(19) United States
(12) Patent Application Publication
(10) Pub. No.: US 2018/0209280 A1
(43) Pub. Date: Jul. 26, 2018

(54) BLADED DISC AND METHOD OF MANUFACTURING THE SAME

(71) Applicant: ROLLS-ROYCE plc, London (GB)

(72) Inventors: John P E FORSDIKE, Derby (GB); Simon E. BRAY, Derby (GB); Gavin J. BAXTER, Derby (GB); Andrew R. WALPOLE, Derby (GB)

(73) Assignee: ROLLS-ROYCE plc, London (GB)

(21) Appl. No.: 15/877,839

(22) Filed: Jan. 23, 2018

(30) Foreign Application Priority Data
Jan. 25, 2017 (GB) 1701238.6

(51) Int. Cl. F01D 5/30; F01D 5/02; B23K 20/12

(52) U.S. Cl. CPC F01D 5/3061; F04D 29/321; B23K 20/129; F01D 5/02

(57) ABSTRACT

A method (56) for fabricating an integral assembly (24) is disclosed. The method comprises providing (56) a first workpiece (26) having a first surface and a second workpiece (30) having a second surface (54), performing a first bonding process between the first surface of the first workpiece (26) and the second surface (54) of the second workpiece (30) the bulk material of the first workpiece having a friction weld property that makes it more difficult to weld than a friction weld property at the surface.

### CROSS-REFERENCE TO RELATED APPLICATION

This disclosure claims the benefit of GB Patent Application No. 1701238.6 filed on 25 Jan. 2017, which is hereby incorporated herein in its entirety.

### FIELD OF THE INVENTION

The present disclosure relates to joining components and finds particular application in joining aerospace workpieces such as drums or discs in an axial end-to-end arrangement or joining components to form a bladed integral assembly and a method of manufacturing the same.

### BACKGROUND

Gas turbine engines are employed in a variety of applications, such as aircraft, and marine vessels, among others. The gas turbine engines generate a thrust from a fluid flow by first compressing an intake air within a compression unit. The compression unit utilizes a series of bladed discs or bladed rings for compressing the intake air. The compression unit supplies the compressed air to be mixed with a fuel mixture for combustion in a combustion unit. The resulting hot, high pressure gaseous mixture is expanded through a turbine portion to extract energy which drives the compressors and a propulsor such as a fan or propeller. Energy may also be extracted in the form of electrical power.

The bladed discs are a unitary construction having a disc (or a drum) and a number of blades spaced apart from each other. If the disc and the blade are integrated as a single piece, weight saving may be achieved. As a result, non-mechanical methods of joining the blades have been proposed, wherein the bladed discs are machined from a single forged piece. However, such methods suffer from manufacturing challenges due to less efficient utilization of expensive materials and expensive forging machinery.

Due to technical challenges associated with a high temperature environment, the bladed discs are required to be fabricated with dissimilar materials. However, there are technical challenges in joining two dissimilar materials. For example, joining of the dissimilar materials, i.e. a blade and disc alloys having different crystal structures, differences in thermal processing (i.e. heat treatment) requirements and difficulty in joining using a solid state or melting processes, such as a fusion welding. Further, the fusion welding may give unfavorable post weld mechanical properties due to a heat affected zone and mixing of alloys, increased grain size and lack of post weld homogenisation heat treatment. Furthermore, the dissimilar materials have different characteristics, i.e. weld induced residual stress or optimum material condition (e.g. aging) and hence there are always challenges in joining the dissimilar materials. Furthermore, the welding procedures of the dissimilar materials may require large and costly setups. Therefore, there is a need for an improved bladed disc that is fabricated from the dissimilar materials and further a method of manufacturing the same is proposed.

### SUMMARY OF THE INVENTION

The present disclosure concerns a bladed disc for a gas turbine engine. In some examples, a bladed disc and methods for fabricating the same are disclosed.

The bladed disc (also called an integral assembly) may be used in a low pressure turbine, an intermediate pressure turbine or a high pressure turbine. It may also find application in the compressor section of the gas turbine.

The high pressure turbine is exposed to the hottest, highest pressure air, and the low pressure turbine is subjected to cooler, lower pressure air.

According to various, but not necessarily all, embodiments of the disclosure there is provided a method of fabricating an integral assembly. The method comprising: providing a first workpiece having a first surface and a second workpiece having a second surface; the first workpiece having a bulk friction-weld property and a surface layer friction-weld property different from the bulk friction weld property, the first surface exhibiting the surface layer friction-weld property, performing friction welding between the first surface of the first workpiece and the second surface of the second workpiece to form the integral assembly.

The integral assembly may be selected from a group comprising bladed discs, bladed drums and/or bladed rings.

The bulk friction weld property is a property of the material that is substantially consistent throughout the first workpiece. The property determines how easy or difficult it is to friction weld the material. The surface layer friction weld property is a property of the material of the first workpiece in a layer at the surface of the first workpiece. The property determines how easy or difficult it is to friction weld the material of the first workpiece within the layer. The layer may be provided by adding new material onto the first workpiece or by chemically and/or mechanically altering the properties of the workpiece at the surface. The surface layer friction weld property preferably indicates that it is easier to friction weld than the bulk friction weld property.

The friction welding may comprise linear friction welding, rotary friction welding, orbital friction welding, stir welding or other friction welding methods.

The first workpiece may be prepared by forming a surface layer by additive layer manufacture.

The additive layer manufacture may be selected from one or more of the group comprising: direct laser deposition, electron beam welding or laser powder bed.

The first workpiece may be manufactured from a single-crystal nickel super alloy, a directional solidification (DS) super alloy or a polycrystalline super alloy, or a single-crystal nickel super alloy, or a directional solidification (DS) super alloy or a polycrystalline super alloy, a wrought or cast alloy.

The second workpiece may be manufactured from a single-crystal nickel super alloy, a directional solidification (DS) super alloy or a polycrystalline super alloy, or a single-crystal nickel super alloy, or a directional solidification (DS) super alloy or a polycrystalline super alloy, a wrought or cast alloy.

The second workpiece may have a further bulk friction-weld property and a further surface layer friction-weld property different from the further bulk friction weld property, the further second surface exhibiting the surface layer friction-weld property,

The second workpiece may be prepared by forming a second surface layer by additive layer manufacture.

The additive layer manufacture may be selected from one or more of the group comprising: direct laser deposition, electron beam welding or laser powder bed.

The further bulk friction weld property and the further surface layer friction weld property may be hardness and the further bulk friction weld property may be harder than the further surface friction-weld property.

The bulk friction weld property may be harder than the surface friction-weld property.

In an alternative embodiment the friction weld property may be selected from the group comprising flow stress or rate of softening where the surface friction weld property is a greater rate of softening than the bulk friction weld property and/or the surface friction weld property is a lower flow stress than the bulk friction weld property.

In a further alternative embodiment the friction weld property may be related to the size of the grain of the material. The bulk friction weld property may exhibit a coarse grain whilst the surface friction-weld property may exhibit a finer grain microstructure.

In a further alternative embodiment the friction weld property may be related to the amount of gamma in the alloy phase. The bulk friction weld property may be a lower amount of gamma than the surface friction-weld property.

The further surface friction-weld property may be harder than the surface friction-weld property.

The bladed disc may be manufactured such that the bulk friction-weld property is different to the further bulk friction-weld property.

The bladed disc may be a fan bladed disc, a compressor section bladed disc or any other bladed disc.

The integral assembly may be selected from a group comprising bladed discs, bladed drums and/or bladed rings.

The first workpiece may be a blade, and the second workpiece may be a disc.

The friction welding may comprise linear friction welding, orbital friction welding, stir welding or other friction welding methods.

The first workpiece and the second workpiece are positioned such that the first surface of the first workpiece abuts the second surface of the second workpiece before carrying out the friction welding.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 illustrates a sectional view of a gas turbine engine;

FIG. 2 illustrates a side view showing a bladed disc assembly;

FIGS. 3A, 3B and 3C illustrate perspective views of the first workpiece and the second workpiece being combined to form the bladed disc;

FIG. 4 illustrates an inertia welding process

FIG. 5 illustrates some process conditions and phases in an inertia welding process

### DETAILED DESCRIPTION OF THE DRAWINGS

In the following description, the wording ‘contact’, ‘abut’, ‘connect’ and ‘couple’, and their derivatives, mean operationally contacting, abutting, connecting and coupling. It should be appreciated that any number of intervening components may exist, including no intervening components.

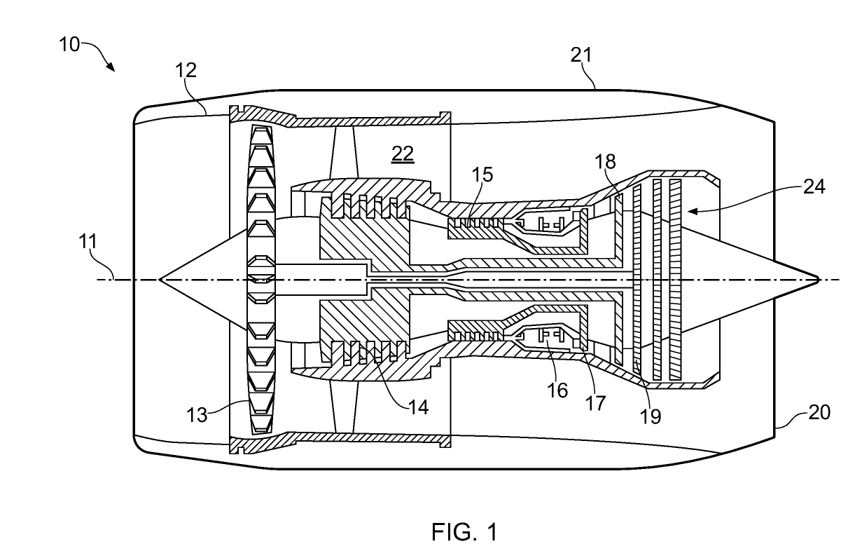

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, a combustion equipment 16, a high-pressure turbine 17, an intermediate pressure turbine 18, a low-pressure turbine 19 and an exhaust nozzle 20. A nacelle 21 generally surrounds the engine 10 and defines both the air intake 12 and the exhaust nozzle 20.

The gas turbine engine 10 works in the conventional manner so that air entering the air intake 12 is accelerated by the propulsive fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high pressure turbine 17, the intermediate pressure turbine 18 and the low-pressure turbine 19 before being exhausted through the exhaust nozzle 20 to provide additional propulsive thrust. The high pressure turbine 17, the intermediate pressure turbine 18 and the low-pressure turbine 19 drive respectively the high pressure compressor 15, the intermediate pressure compressor 14 and the propulsive fan 13, each by suitable interconnecting shaft.

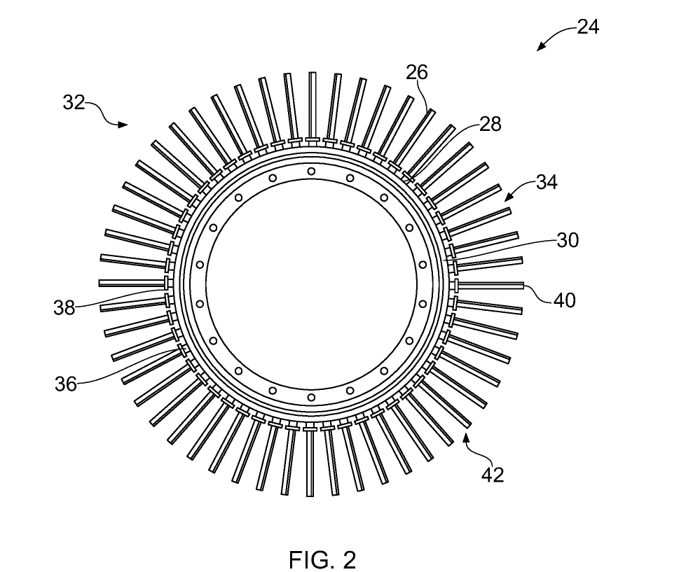

The high-pressure turbine 17, the intermediate pressure turbine 18, and the low-pressure turbine 19 may all be formed as a bladed disc 24. The bladed disc 24 is shown in FIG. 2 and comprises a disc 30 integrally formed with multiple blade 26 on its peripheral surface. The method of the present disclosure finds particular utility in manufacturing the bladed disc 24 when the disc 30 and the blade 24 have different material properties.

Other gas turbine engines to which the present disclosure may be applied may have alternative configurations. The gas turbine engines disclosed herein may be utilized across various applications, i.e. an aerospace or marine gas turbines, among others. By way of example such engines may have an alternative number of interconnecting shafts (e.g. two) and/or an alternative number of compressors and/or turbines. Further the engine may comprise a gearbox provided in the drive train from a turbine to a compressor and/or fan.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

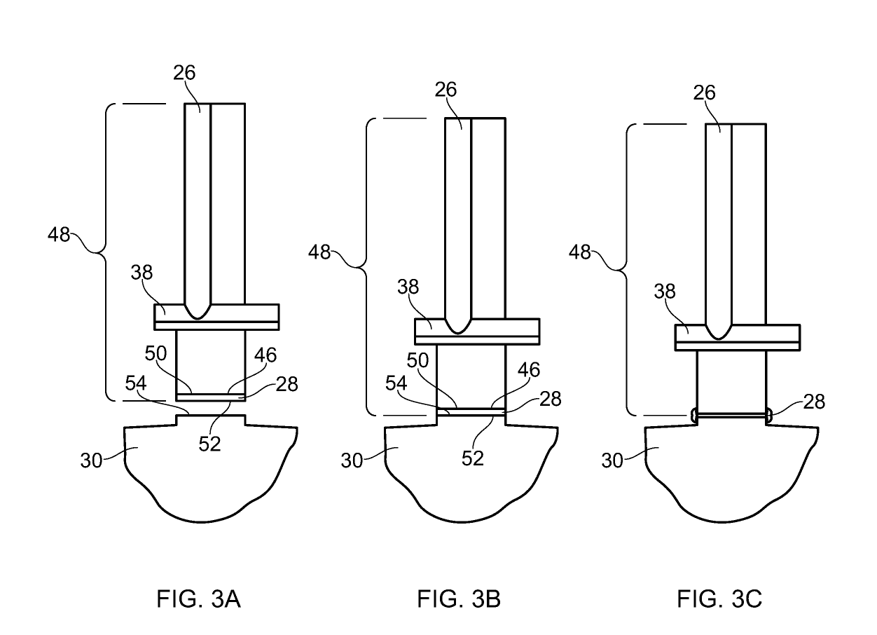

With reference to FIGS. 2 and 3, as used herein, terms “bladed disc assembly” or “bladed disc” or “integral assembly” are used herein to refer to any gas turbine engine 10 components which includes a hub, i.e. the disc 30 having the multiple blades 26 integral therewith. Such components are sometimes also referred to as “bladed disc” or “integrally bladed rotor”. The present disclosure is especially useful for bladed discs used in the gas turbine engine 10, but is applicable to any kind of bladed disc structure. The term “bladed disc assembly 24” may be interchangeably used with “the bladed disc 24” within the specification without departing from the meaning and scope of the disclosure. The term “first workpiece 26”, “second workpiece 30”, may be interchangeably used with terms “blade 26”, and “disc 30” respectively without departing from the meaning and scope of the disclosure. In accordance with the present disclosure, the bladed disc assembly 24 includes a first workpiece 26 (i.e. the blade 26), a second workpiece 30 (i.e. the disc 30) around the circumference of which is disposed of the multiple blades 26 (shown as 32) in an annular array. The plurality of blades 26 extend from the disc 30 in an outwardly radial and axial direction. As will be appreciated by those skilled in the art, the first workpiece 26 may have varying configurations, i.e. shape, thickness without departing from the meaning and scope of the disclosure. The number and orientation of the first workpiece 26 around the circumference of second workpiece 30 may also vary without departing from the meaning and scope of the disclosure. In an embodiment, material properties of the first workpiece 26 are different from material properties of the second workpiece 30.

With reference to FIGS. 2 and 3, the blade 26 comprises an aerofoil 34, a root 36, a platform 38, and a tip 40. The blade 26 is connected to the disc 30 via the root 36. The platform 38 extends axially and circumferentially. The bladed disc assembly 24 has a generally radial structure and, a central bore area (not shown). In operations, the bladed disc assembly 24 is disposed on a central axis (not shown) at the central bore area (not shown) and rotates thereon or rotates with the axis (not shown). The bladed disc assembly 24 further defines an upstream position and a downstream position. The upstream position and the downstream position correspond to the fluid path flow through and across the bladed disc assembly 24. Fluid, and more specifically air, first enters the bladed disc assembly 24 at the upstream position. As air passes the bladed disc assembly 24, the air exits via the downstream position. The direction of the air flow (not shown) moves across the face of the bladed disc assembly 24, wherein the face being that portion of the bladed disc assembly 24 which is exposed to air flow. In operation, the bladed disc assembly 24 may be disposed within a housing or structure (not shown) which, by close proximity to the blades 26 (shown as 32), assists in placing the air under pressure.

With reference to FIGS. 3A, 3B, and 3C, an integral assembly, i.e. the bladed disc 24 is manufactured. The integral assembly 24 is selected from a group comprising bladed discs, bladed drums and/or bladed rings. In an embodiment, the integral assembly 24 is the bladed disc 24. The bladed disc 24 comprises the first workpiece 26, the second workpiece 30. The first workpiece 26 is coupled to the second workpiece 30. The first workpiece has a surface layer with a surface that is used to join the first workpiece and the second workpiece. The material properties of the surface layer 28 are different from bulk material properties of the first workpiece. It will be apparent to one skilled in the art that the first workpiece 26, the second workpiece 30 may be of any shape, design, or characteristics other than as illustrated here.

The first workpiece 26 includes a first surface 52. The blade 26 may be a single crystal super alloy or a directional solidification (DS) super alloy or a polycrystalline super alloy, such as but not limited to CMSX-4®, CMSX-2®, MAR-M002® or CM247® and other similar super alloys.

As will be appreciated by those skilled in the art, the blade 26 may be manufactured from various other types of alloys, such as Nickel based alloys, Chromium based alloys, Tungsten based alloys, Aluminium based alloys or other metal alloys or intermetallics not described herein without departing from the meaning and scope of the disclosure. The single crystal nickel alloy and casting technology offer a combination of properties for advanced gas turbine engine components. The alloys are designed to produce superior properties for a challenging combination of requirements, such as high temperature creep-strength, fatigue resistance, oxidation resistance, coating performance and retention of performance in thin-walled configurations. The blade 26 is provided with the surface layer using an additive layer process. Such processes are known in the art and incorporate high temperature (+600° C.) processes using blown powder or wire feed to place material into a melt pool formed on the first component or powder bed processes where powder is added to the first component and melted thereon. Where the added material is chemically or visually distinct from the parent alloys of the first, or second workpiece it is possible to enable a quality control inspection of the flash either in-situ or post-weld for evidence of the added material.

With reference to FIGS. 3A, 3B, and 3C, the first workpiece 26 is joined with the second workpiece 30 by friction welding. A surface 52 of the first workpiece 26 is prepared, prior to make the third surface 52 suitable for the friction welding process, by machining away any oxide layer and then washing the machined surface with suitable degreasing agents or cleaning agents. Similarly, a surface 54 of the second workpiece 30 is also prepared for the friction welding process by ensuring that cleaning has been done properly. Cleaning of the first and second workpieces helps to ensure a consistent weld.

In an embodiment, the friction weld process is a linear friction welding or an orbital friction welding. The linear friction welding is processed between the surface 52 of the first workpiece 48 and the surface 54 of the second workpiece 30. The linear friction welding utilized heat generated from friction to couple the first workpiece 26 with the second workpiece 30. Friction heats the material to a plastic state in conjunction with an applied force to create the weld. The friction welding may also be designed in such a way that it ensures that the first workpiece 26 is protected from undesirable heat and stress. The orbital friction weld may be another welding process for a reliable weld between the first workpiece 26 and the second workpiece 30. As will be appreciated by those skilled in the art, the second bonding process may use any other solid state type welding or any other technique.

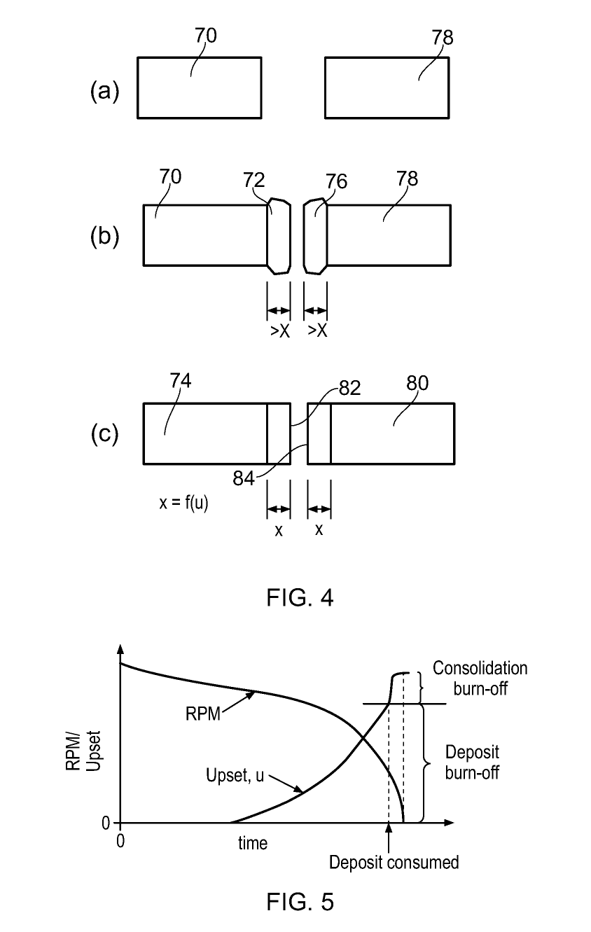

A further embodiment is described with reference to FIGS. 4 and 5. In this embodiment the first workpiece 70 and the second workpiece 78 are of the same or a different material.

A layer of material 72 is formed on the first workpiece and a layer of material 76 is formed on the second workpiece 78 using additive layer manufacture.

A surface 82 of the first workpiece is presented to a surface of the second workpiece 84 and a second bonding process, which may be linear friction welding or an orbital friction welding or an inertia welding process joins the first workpiece with the second workpiece. The friction or inertia welding utilized heat generated from friction to couple the first workpiece 74 with the second workpiece 80. Friction heats the material to a plastic state in conjunction with an applied force to create the weld.

Upset material is ejected by the second bonding process as flash and it is possible to control the welding process, along with the thickness of the additive layers to determine whether all of the material of the first and/or second workpiece is ejected as flash or whether a proportion is retained in the final integral assembly.

FIG. 8 illustrates the key phases of an inertia welding process through the relative spin speeds of the first and the second workpiece and upset as a function of time. For a given process, the layer thickness and material can be tailored to allow the desired temperature profile for the first workpiece and the second workpiece at the end of the upset. This tailoring can include an optimum surface speed for the final burn-off phase. This approach coupled with a two-stage pressure welding process could be used to a) optimise second and fourth layer burn-off and b) optimise consolidation of the first and second workpieces.

In a first embodiment the bulk material exhibits a hardness that is greater than the material hardness exhibited by the surface layer. The hardness may be adjusted by e.g. forming the new layer by deposition of a new material onto the bulk material or by diffusing a new element into a surface of the bulk material and which alloys with the bulk material at the surface to provide the surface layer.

In a further embodiment which may be used with the first embodiment or separately the friction weld property may be related to the size of the grains in the material. The bulk friction weld property exhibit a coarse grain whilst the surface friction-weld property may exhibit a finer grain microstructure than in the bulk material.

The finer grain microstructure surface layer may be provided by either depositing a new material onto the bulk material or by diffusing a new element into a surface of the bulk material and which alloys with the bulk material at the surface to provide the surface layer.

The proposed embodiments of the disclosure offer various advantages. The proposed disclosure enables bonding two different materials of varying material properties. Further, the proposed disclosure provides flexibility to use known technology, such as a solid state welding for bonding the blade 26 with the disc 30. The proposed techniques may also be used to repair bladed discs, which in service experience very hostile environments and undergo different kinds of damage.

Further, the proposed technology is easily applied to facilitate joining of other structures with internal holes or similar discontinuities e.g. a fan bladed disc, metal-matrix-composite bladed disc. The bladed disc assembly 24 may be fabricated from dissimilar material, for example, components made of a composite material which cannot be satisfactorily joined through a friction welding.

The proposed technology should also find use in the joining of adjacent cylindrical components such as drums or discs. These have circumferential surfaces and axial surfaces and the axial surfaces have a friction weld property that is easier to weld than the bulk friction weld property.

Further, the proposed disclosure facilitates joining of ceramic or ceramic based workpiece to a metallic workpiece. The proposed disclosure is also applicable for joining inter-metallic materials to a metallic, or joining of bladed discs with hollow cavities within the blade 26, or joining of bladed discs with a discontinuity in shape or construction within the blade 26.

It will be appreciated by one skilled in the art that, where technical features have been described in association with one embodiment, this does not preclude the combination or replacement with features from other embodiments where this is appropriate. Furthermore, equivalent modifications and variations will be apparent to those skilled in the art from this disclosure. Accordingly, the exemplary embodiments of the disclosure set forth above are considered to be illustrative and not limiting.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

In addition the method and process enables joining of components that are currently effectively impossible to inertia weld because or inertia required to join them being significantly in excess of the inertia available on the largest machine commercially available. Advantageously, the capital infrastructure required to join these components is lowered.

1. A method for fabricating an integral assembly, the method comprising:
Providing first workpiece having a first surface and a second workpiece having a second surface;
the first workpiece having a bulk friction-weld property and a surface layer friction-weld property provided by additive layer manufacture and which is different from the bulk friction weld property, the first surface exhibiting the surface layer friction-weld property,
performing friction welding between the first surface of the first workpiece and the second surface of the second workpiece to form the integral assembly.

2. A method according to claim 1, wherein the integral assembly is selected from a group comprising bladed discs, bladed drums and/or bladed rings.

3. A method according to claim 1, wherein the friction welding comprises linear friction welding, rotary friction welding, orbital friction welding, stir welding or other friction welding methods.

4. A method of claim 1 wherein the additive layer manufacture is selected from one or more of the group comprising: direct laser deposition, electron beam welding or powder bed.

5. A method according to claim 4, wherein the first workpiece is manufactured from a single-crystal nickel super alloy, a directional solidification (DS) super alloy or a polycrystalline super alloy.

6. A method according to claim 5, wherein the second workpiece is manufactured from a single-crystal nickel super alloy, or a directional solidification (DS) super alloy or a polycrystalline super alloy.

7. A method according to claim 1, the second workpiece having a further bulk friction-weld property and a further surface layer friction-weld property different from the further bulk friction weld property, the further second surface exhibiting the surface layer friction-weld property.

8. A method of claim 7 further comprising preparing the second workpiece by forming a second surface layer by additive layer manufacture.

9. A method of claim 7 wherein the additive layer manufacture is selected from one or more of the group comprising: direct laser deposition, electron beam welding or laser powder bed.

10. A method according to claim 7, wherein the further bulk friction weld property and the further surface layer friction weld property is hardness and the further bulk friction weld property is harder than the further surface friction-weld property.

11. A method according to claim 1, wherein the bulk friction weld property and the surface layer friction weld property is hardness and the bulk friction weld property exhibits a hardness greater than the surface friction-weld property.

12. A method according to claim 11, wherein the further surface friction-weld property is harder than the surface friction-weld property.

13. A method for fabricating an integral assembly, the method comprising:
providing a first workpiece having a bulk friction-weld property and providing a layer of material formed by additive manufacture onto first workpiece to provide a first surface;
providing a second workpiece having a second surface; wherein
the first workpiece has a bulk friction-weld property and a surface layer friction-weld property different from the bulk friction weld property, the first surface exhibiting the surface layer friction-weld property,
performing friction welding between the first surface of the first workpiece and the second surface of the second workpiece to form the integral assembly.

14. A method of claim 13 wherein the additive layer manufacture is selected from one or more of the group comprising: direct laser deposition, electron beam welding or powder bed.

15. A method according to claim 14, wherein the first workpiece is manufactured from a single-crystal nickel super alloy, a directional solidification (DS) super alloy or a polycrystalline super alloy.

16. A method according to claim 15, wherein the second workpiece is manufactured from a single-crystal nickel super alloy, or a directional solidification (DS) super alloy or a polycrystalline super alloy.

17. An integral assembly, comprising:
a first workpiece having a bulk friction-weld property and a layer of material formed by additive manufacture on first workpiece;
a second workpiece friction welded to the layer of material formed by additive manufacture; wherein
the first workpiece has a bulk friction-weld property and the layer of material formed by additive manufacture has a friction-weld property different from the bulk friction weld property.

18. An integral assembly according to claim 17 wherein the additive layer manufacture is selected from one or more of the group comprising: direct laser deposition, electron beam welding or powder bed.

19. An integral assembling according to claim 18, wherein the first workpiece is manufactured from a single-crystal nickel super alloy, a directional solidification (DS) super alloy or a polycrystalline super alloy.

20. An integral assembly of claim 17, wherein the friction-weld property of the layer formed by additive manufacture is softer than the bulk friction-weld property.
